(19) United States
(12) Patent Application Publication
(10) Pub. No.: US 2006/0031840 A1
(43) Pub. Date: Feb. 9, 2006

(54) Real time monitoring manufacturing scheduling and control

(75) Inventors: Ahmet Yigit, Raleigh, NC (US); James Pierre, Marietta, GA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignees: ABB Inc.; ABB TECHNOLOGY AG.

(21) Appl. No.: 10/644,512

(22) Filed: Aug. 20, 2003

(51) Int. Cl. G06F 9/46

(52) U.S. Cl. 718/102

(57) ABSTRACT

A method and system for visually displaying real-time enterprise management information is provided. An application integration platform receives plural types of data from manufacturing and information systems within an enterprise and analyzes the plural types of data to determine key performance indicators, such as a number of tardy jobs. A process control server receives manufacturing data from at least one work center and forwards the manufacturing data to the application integration platform. A user interface that interfaces with the application integration platform provides a visual display of the number of tardy jobs in accordance with the class of user interacting therewith. The user may then reschedule the tardy jobs on alternate machines and determine how such rescheduling will affect the expected completion times of all jobs running on all machines.

### FIELD OF THE INVENTION

This invention relates in general to the field of information management. More particularly, the invention relates to a system and method of real-time monitoring and visualizing of manufacturing processes and other key business processes.

### BACKGROUND OF THE INVENTION

Managing daily business activities efficiently is very important to keep operating costs low and customers satisified. In today's business world, it is very difficult and complicated to obtain real-time information necessary to manage business processes and monitor assets. Using incomplete or inaccurate data can lead to strategic and tactical mistakes, long lead times, high work in progress (WIP), and quality problems. These problems cost businesses time and money due to higher capital expenses, decreased cash flow through lower inventory turnover, higher saftey/buffer stocks, and decreased availability.

Conventional systems do not provide an efficient, flexible and reliable system to monitor the daily, and short and long term activities of an enterprise in real-time. Thus, in view of the foregoing, there is a need for systems and methods that overcome the limitations and drawbacks of the prior art. In particular, there is a need for system that can monitor the activities of an enterprise in real-time to address the limitations of the prior art and provide decision makers with the information they need. The present invention provides such a solution.

### SUMMARY OF THE INVENTION

The present invention provides a system for visually displaying real-time enterprise management information. In accordance with an aspect of the invention, there is provided systems and methods for visually displaying real-time enterprise status information related to a status of jobs running on machines. The systems and methods include an application integration platform that receives the real-time enterprise status information and analyzes the information to determine at least one key performance indicator, a process control server that receives status information from at least one work center and forwards the status information to the application integration platform, a database containing information related to manufacturing processes performed at the at least one work center, and a graphical user interface that interfaces with the application integration platform to provide a visual display of the at least one the key performance indicator. The system provides for minimizing the number of tardy jobs running on machines within the at least one work center.

In accordance with a feature of the invention, jobs are initially scheduled on the machines and the system provides for control of scheduling after jobs are released to the work center shop floor. Jobs may be rescheduled from one machine to another in accordance with an expected completion time. The expected completion time is determined based on an average completion time for a set of jobs assigned to the machines plus a total variation for all jobs in the machines.

The system may graphically present scheduled jobs for each machine and an expected completion time, wherein the expected completion time includes any tardiness. A maximum number of tardy jobs is defined as:

$${\begin{matrix}Max \{ {d}_{i} - {E}_{m} < 0 \} \\ i ∈ K\end{matrix}}_{m ∈ M}$$

$$wherein$$

$$Em = {T}_{c} + {\sum }_{i = 1}^{k} {μ}_{i} + {z}_{α / 2 σ 1 …k}$$

and wherein
   dᵢ=Due date for job i
   Eₘ=Expected completion time of the jobs on machine m
   M=Machine set
   K=Set of jobs scheduled on selected machine
   z_{α}=Standard normal distribution coefficient for given risk, α
   σᵢ=Standard deviation for a particular job in machine M
   μᵢ=Average duration for a particular job in machine M
   T_{c}=Current time.

As expected completion time for a set of jobs may defined as:

$${Min}_{j = 1}^{M} \{ {T}_{c} + {\sum }_{i = 1}^{k} {μ}_{i} + {z}_{α / 2} {σ}_{mT} \}$$

where
   σ_{mT}=SQRT(σ₁+σ₂+ . . . +σₙ)
Where
   M=Machine set
   K=Set of jobs scheduled on selected machine
   z_{α}=Standard normal distribution coefficient for given risk, α
   σ_{mT}=Total standard deviation for set of jobs in machine m
   μᵢ=Average duration for a particular job in machine M
   T_{c}=Current time

In accordance with another aspect of the invention, an uncertainty level is assigned based on an expected completion time for jobs, the uncertainty time being a time within which it is expected that a predetermined percentage of the jobs will be completed.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIGS. 2-6 illustrate the architecture and components of the present invention;

FIG. 7 illustrates the various levels of detail and information that may be provided to different classes end-users within an enterprise;

FIGS. 8-15 illustrate exemplary user interfaces and output reports provided by the present invention; and

FIGS. 16-17 illustrate scheduled jobs on various machines in a manufacturing facility.

### DETAILED DESCRIPTION OF PREFERRED EMBODIMENTS

Given the complex manufacturing systems and market conditions, scheduling has a critical impact on a company's performance. Moreover, after a schedule is made and released to the shop floor, assessing the manufacturing performance in a shop floor in a timely matter is very difficult. Even if jobs are scheduled optimally, after they are released the shop floor, there may be delays in throughput. Throughout the production cycle there will be several reasons which will prevent the jobs from being completed on time. For example, a released job might have different priority due to a customer request. In this case, one should able to evaluate best options to finish the job on time to satisfy the customer. Reasons such as missing material, machine breakdown, wrong Bills of Material, absenteeism, etc., make it very difficult to control and monitor in the shop floor to prevent late deliveries.

The present invention is directed to systems and methods for monitoring whole enterprise processes and key performance indicators (KPI) both locally and remotely. Classes of users (e.g., managers, engineers, operators, etc.) are able to monitor KPIs, such as financial indicators, market activities, overall company conditions, throughput, available capacity, machine status, quality information, etc. Decisions can be made on day-to-day activities, and short and long term activities based on the monitored results. The present invention includes software that is based on an object-oriented architecture to provide a platform that can be easily configured and scaled to increase functionality and enterprise growth.

The methodology described herein is a robust and easy way to assess a scheduling status of jobs in the shop floor in real time and change the job scheduling if necessary.

Exemplary Computing Environment

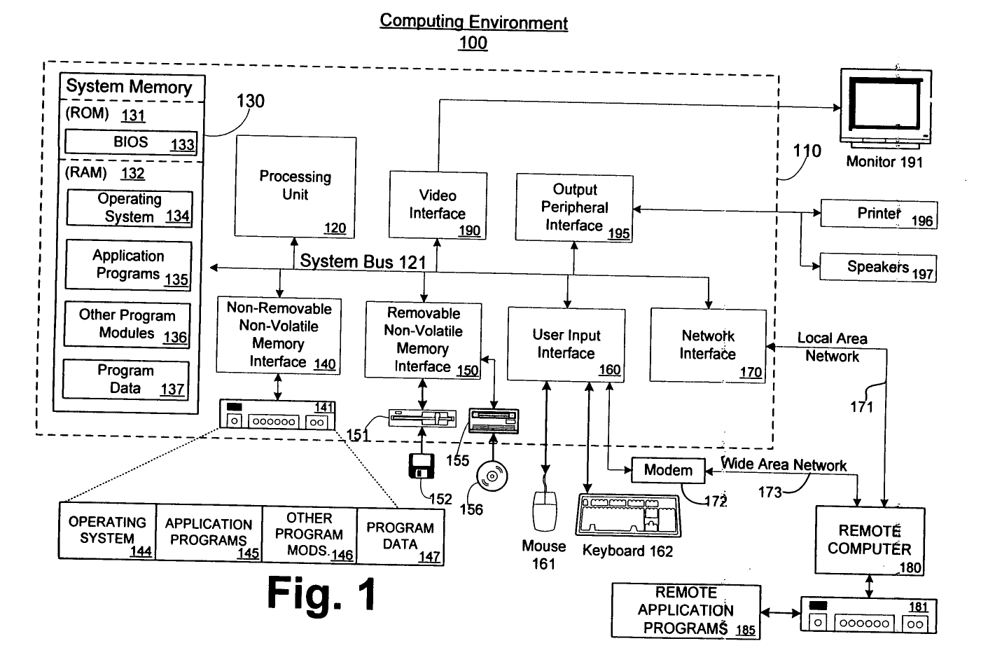

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 140 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Distributed Computing Framework and Architecture

The present invention is directed to systems and methods for monitoring whole enterprise processes and key performance indicators (KPI) that provides for decoupling of functionality into individual, standalone, reusable subsystems. The present invention provides small, simple interfaces between components, and similarity of concepts within the architecture. The decomposition of the system into reusable components is performed in such a way, that the system can be adapted to changes in requirements via an exchange of a minimal set of components. To accomplish these goals, the present invention is preferably implemented using VB coding standards.

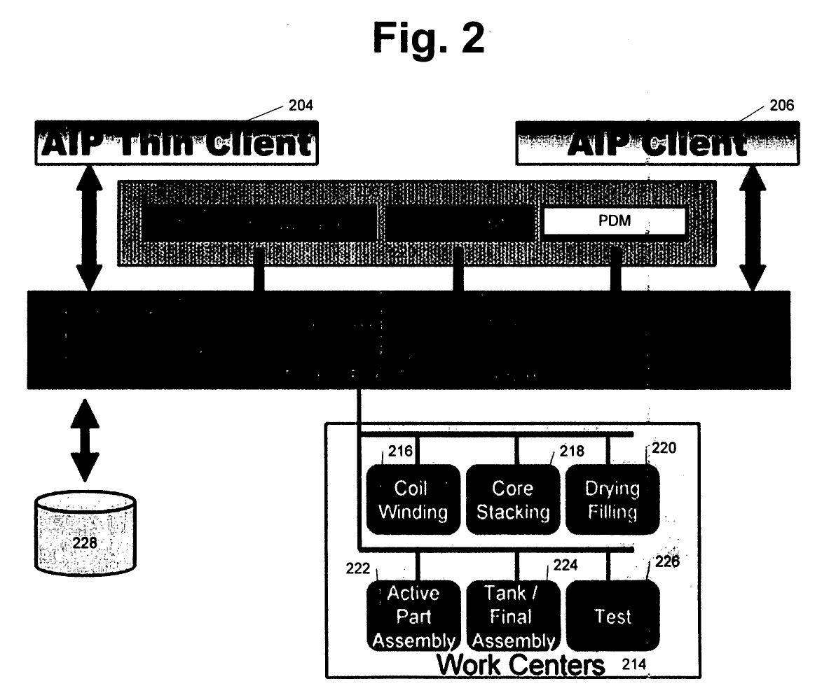

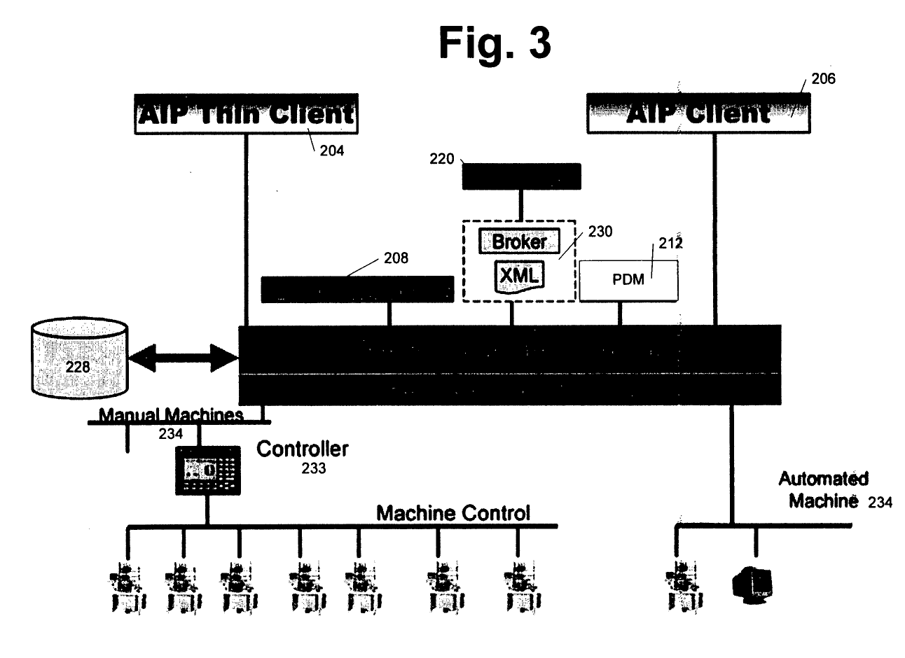

Referring to FIGS. 2-6, the present invention integrates the disparate manufacturing and information systems into an Application Integrator Platform (AIP) platform 200. The AIP platform 200 may be implemented on a computer similar to computer 110 and receive data from several systems and to provide visual monitoring. The AIP is platform independent, and may be implemented using VB coding standards, JAVA, or within a Net Environment. If the platform 200 needs financial information, the data may be extracted from an Enterprise Resource Planning (ERP) system 220 via an exchange of XML data 230 in real-time (see, FIG. 3). The common visualization program enables the sharing of business content and data across the enterprise by supporting integration to Enterprise Resource Planning (ERP) system 220 via an exchange of XML data 230 in real-time (see, FIG. 3) for financial information or to other enterprise applications such as Quality, Manufacturing, Execution System (MES) 208, Product Data Management (PDM) 212, etc. The ERP system 220 preferably comprises R/3 release 4.6C, available from SAP AG The MES 208 and PDM 212 may comprise Lotus Notes, available from IBM Corporation.

Users interact with the system by logging on to the AIP 200 locally, or remotely using a WWW interface via the Internet. Preferably, two interfaces are implemented, an AIP Thin Client 204 for the BA view, and an AIP Client 206 for the BAU view. The BAU shows a Business Area Unit (e.g., a manufacturing facility or business), whereas the BA view shows a Business Area (a group of common BAUs). The AIP Thin Client 204 and AIP Client 206 may be implemented on, e.g., computer 110 to connect to various components via a LAN 236 and/or corporate intranet 240. In addition, other components may communicate with each other via the LAN 236 or wireless access points 238 and bridges 239. Business activity can be graphically monitored by the system in real-time to allow users to react and make critical business decisions based on performance information.

Manufacturing status data 214 may be gathered via a barcoding system or machine sensors and/or other controls from, e.g., a coil winding machine 216, core stacking machine 218, drying/filling machine 220, active part assembly machine 222, tank/final assembly machine 224 and/or test machine 226. It is noted that the present invention is not limited to such machines and/or data, and may be utilized to capture and analyze data from other types of machines and information sources. Barcode data gathering techniques are well know to those of ordinary skill in the art and equipment therefor is available from, e.g., Symbol Technologies, Holtsville, N.Y.

FIGS. 3-5 illustrate architecture of FIG. 2 with particular reference to the Coil Winding machine 216. The winding machine 216 may be monitored via well known sensors to track machine status (e.g., on/off) and state (e.g., turning). Data related with manufacturing may be gathered from feedback points in the plants using sensors and the barcode system (including database 228). Data signals will be sent directly to an OLE from Process Control (OPC) server 202.

Those of ordinary skill in the art will understand that OPC is a series of standards specifications. The first standard (called the OPC Specification and now called the Data Access Specification) resulted from the collaboration of a number of leading worldwide automation suppliers working in cooperation with Microsoft Corp. Originally based on Microsoft's OLE COM (component object model) and DCOM (distributed component object model) technologies, the specification defined a standard set of objects, interfaces and methods for use in process control and manufacturing automation applications to facilitate interoperability. The COM/DCOM technologies provided the framework for software products to be developed. There are now hundreds of OPC Data Access servers and clients.

When sensor signals are sent to the OPC Server 202, the Aspect Integrator Platform (AIP) 200 or Web Interface will be used to gather the data and display the information to the end users. This data will include operator activities from the data feedback points in the manufacturing plant. Manual machines 232 may have optical and voltage sensors to measure status of the manufacturing, which are sent to a controller 233 for transmission to the OPC Server (OLE for Process Control) 202. For highly automated machines 234, which have the built in controller, the signals are sent directly to the OPC server 202. The AIP 200 may extend across a single or multiple disparate locations to extent the value chain and enable real-time correlation.

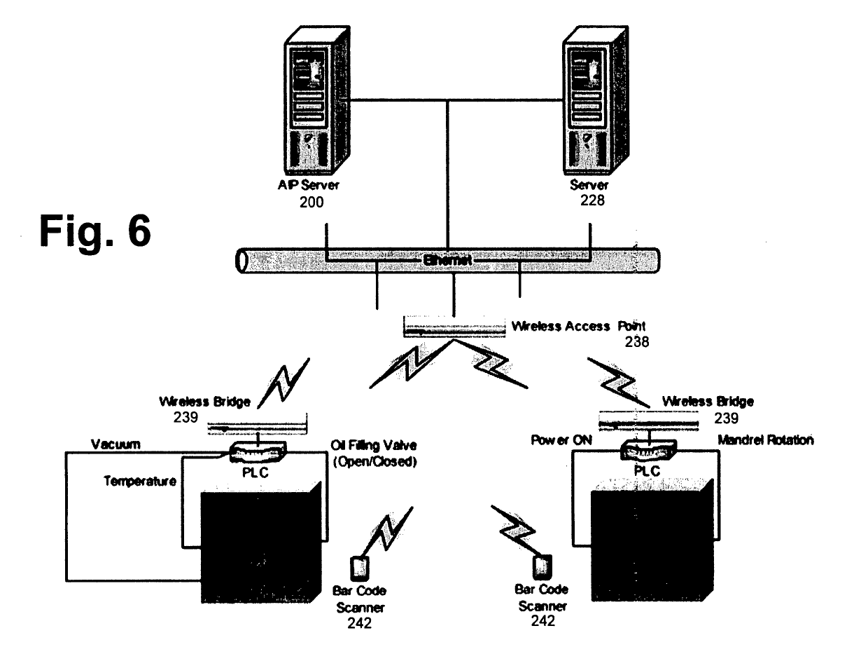

As shown in FIG. 6, there is the test oven 220 as monitored by the present invention. The oven may be monitored via well known sensors to track temperature, vacuum, etc. and the data therefrom communicated via the wireless access point 238 and the wireless bridges 239 to the AIP platform 200. Barcoding techniques may also be used to track activities via SAP data and ERP System 220. As is now evident to those of ordinary skill in the art, any performance characteristic of any machine on the shop floor may be monitored by the present invention by collecting data therefrom.

In accordance with the present invention, the following exemplary key performance indicators (KPI) may be monitored by the API 200 of the present invention:

1. Throughput Time (Days)

Throughput time may be calculated for overall manufacturing and for each process as days spent in production for a project name, unit, and work order:

Throughput time=Completion time−start time (for work order, project name, and unit).

In accordance with the present invention, users may calculate a throughput time for given dates, project name, work order, and unit. For example, if a user wants to see all project throughput times for last 30 days, the user will be able to view a project name and its associated throughput times. If he/she wants to see a particular project or unit throughput time, he/she should be able to see the project name or unit throughput time as a whole or for individual work centers.

2. Manufacturing Hours (Total and by Activity)

Manufacturing time may be calculated for each activity in the shop floor as hours spent on a project, work order, and unit. This KPI is similar to throughput time, except that real manufacturing hours is preferably tracked on the shop floor. Manufacturing activities may be defined as, e.g., set up, processing, and set out. Similarly, manufacturing problems may be defined as, e.g., break down, missing parts, quality issues, operator breaks, and technical clarification.

In accordance with the present invention:

Manufacturing time (overall)=end time (or current time)−start time−all problem times (e.g., employee break, technical problems, etc.)

Manufacturing time (for an activity)=end time (or current time) for an activity−start time for the activity−all problem times (e.g., employee break, technical problems, etc.). The present invention gathers information for given work center (e.g., activities and problem time), project name, and unit. Similarly, same time calculation should be performed for manufacturing problems. It is preferable that the user is able to obtain problem codes and times for break down, missing parts, quality issues, operator breaks, and technical clarification. For example, the user should be able to obtain break down times for all projects for a particular work center or all work centers for a given date interval.

3. Work Center Utilization

In accordance with the present invention, work center utilization is a measure of the actual productive time for a work center:

Utilization for a machine=(productive time on the machine)/(endtime−start time).

Machine productive hours are preferably extracted through sensor data. Other required times may come from a database storing such information. It is preferable to obtain labor hours associated with particular work center through an employee ID to calculate total hours spent on the machine. The present invention may obtain these data for a given date and work center. If a user wants to view average work center utilization (i.e., not a particular machine utilization), the present invention preferably calculates average utilization after obtaining machine utilization.

4. Man-Hour Capacity Report

Man-hour utilization is similar to the machine utilization. The present invention calculates total labor hours for each work center as follows:

Man hour utilization=(used man hour)/(total available man hour)

Used man-hour will is preferably calculated in a similar manner as in the work center utilization (KPI 3) above. Total man-hours may be a manual entry and may be determined for user-specified dates.

5. Planned vs. Actual

As part of the project tracking purposes, it is preferable to calculate the following measures with scheduling: the difference between planned start time and actual start time, the difference between planned completion and actual completion time, and the difference between planned hours and actual hours.

Planned start and completion times for a work order are defined as the original scheduling times. Actual start time and completion time may be extracted from, e.g., a database 228. The present invention provides the user with a view of planned vs. actual time for each work station for a given project name. Users may also want to track planned vs. actual for each project for a given work center. For example, if he or she wants to see all the projects status for a winding center, he or she should be able to list all projects with planned vs. actual time in the work center.

6. Work in Process (WIP)

WIP is the number of units in each work center either waiting or processing for a given time. It is often necessary to find out how many units are waiting or processing in the work stations. In exemplary manufacturing environment 214 of the present invention, these are: a number of units in the winding process, a number of cores waiting (i.e., arrived, but not processed, thus are considered raw material), a number of active parts waiting (i.e., finished, but into the next process), a number of complete units waiting for final assembly (i.e., finished, but into the next process), a number of complete units waiting for final testing, a material weight for drums in the winding, and a number of tanks in the system.

The present invention provides WIP quantity by project name, unit, and work order for each station. For example, if user wants to see WIP quantity in the winding machine, all projects, units, and work orders assigned to winding work center are returned.

Additional KPIs may be defined in accordance with the particular needs of the enterprise manufacturing environment.

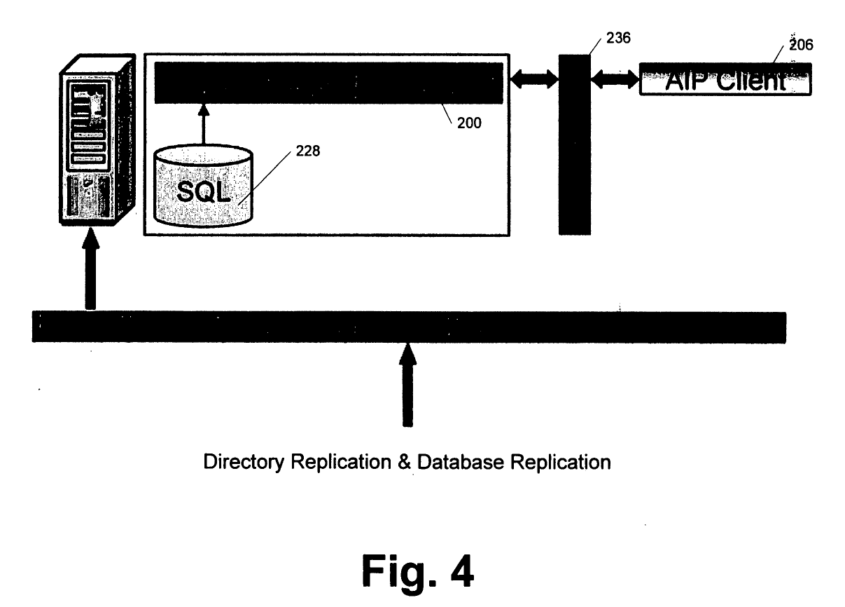

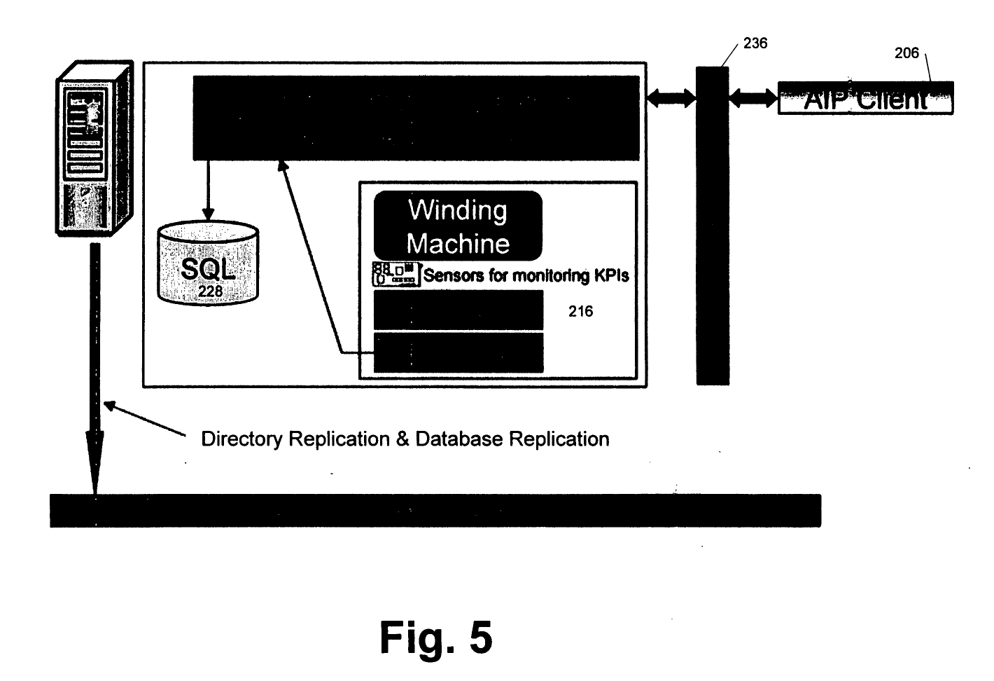

The database 228 of the present invention will now be described. Data storage and replication in database 228 is preferably implemented using SQL Server 2000, available from Microsoft Corp., Redmond, Wash. In the present invention, directory replication and database replication is used for performance optimization. Data is preferably stored and managed locally. The BAU level the relevant KPI are summarized and replicated daily (see, FIG. 5). From the BAU data, the records and aspects are replicated to the BA server (see, FIG. 4) for viewing. The database replication is a functionality of SQL.

Processing at each workstation is maintained by scanning barcodes (using barcode scanner 242) representative of a particular status at the workstation. The data is stored in the database 228 for processing of the KPIs discussed above. Table One, below, relates the KPI monitoring data requirements to determine the KPI value.

TABLE ONE

| Monitoring Requirements | | Data needed |
|---|---|---|
| KPI: | Throughput time (days) | Work Order (WO) number & |
| | Overall manufacturing | related operations numbers |
| | throughput | Work Station ID |
| | Throughput for each processes | Start time for WO (at each station) |
| | Throughput = | End time for WO (at each station) |
| | (end time-start time) | |
| KPI: | Throughput activity analysis: | WO number (at each station) |
| | Set up | Activity code and/or problem code |
| | Processing | Start time for WO (at each station) |
| | Set out | End time for WO (at each station) |
| | Break down | |
| | Missing parts | |
| | Quality issues | |
| | Operator breaks, etc. | |
| KPI: | Utilization: | Work station ID |
| | Machine used “on/off/ | Activity code |
| | break down” | WO number |
| | Machine turning “yes/no” | Employee Information (e.g., badge |
| | Capacity Utilization = (Man- | number) |
| | hour)/(theoretical labor | |
| | capacity) | |
| KPI: | Planned vs. Actual: | WO number (at each work station) |
| | Difference between planned | Planned start time |
| | start time and actual start | Actual start time |
| | time. | Planned completion time |
| | Difference between planned | Actual completion Time |
| | completion and actual | |
| | completion time. | |
| | Difference between planned | |
| | hours and actual hours. | |
| KPI: | WIP for the each activity: | WO number (at each work center) |
| | Units in the winding process. | Work station ID |
| | Number of cores waiting. | Start time for WO |
| | Number of active part | End time for WO |
| | waiting. | Material code |
| | Number of complete unit | |
| | waiting for final assembly. | |
| | Number of complete unit | |
| | waiting for final testing. | |
| | Number of drums. | |
| | Number of tanks in the | |
| | system. | |
| KPI: | Non conformity reports | Work Center |
| | Number of “launched”weekly | SAP mapping |
| | Different status (“launched”, | (to get the product code) |
| | “on treatment”, all excepted | Material code |
| | “solved”) | WO number |
| | Cumulated number of manu- | |
| | facturing hours lost | |
| | Test reports for the final | Test Reports |
| | testing for each unit. | Work station ID |
| Order Tracking: | | WO number (at each station) |
| | Which unit/project at which | Work Station ID |
| | station. | |

As noted above, in accordance with the present invention, data is captured using a barcode system 242 to determine and display the KPIs noted above. The structure of data items, such as databases, OPC servers, and configuration data will now be described. Table Two below defines an exemplary barcode system and type of the data collected or updated during the manufacturing operations. The scope of the claims of the present invention shall not be limited by the exemplary system described below, as other events and processes may be captured by the system of the present invention.

A data collection event, as used herein, is the manufacturing activity that will occur in a particular machine or work center. During these events, data related to the shop floor is collected and updated. For example, when operator starts to work, he or she scans or enters his or her badge number, WO number, and activity code. This activates the work process in the particular workstation and the data will be sent to the database 228 until the next event, which may be, e.g., an “end work,” “pause,” etc. event. In accordance with the present invention, the AIP 200 may access the database 228 to obtain the information in Table Two for presentation to a user.

TABLE TWO

| | | | Pause for | Stop Work for | |
|---|---|---|---|---|---|
| | Start Work | End Work | Regular Breaks | a Problem | Quantity Report |
| Procedure | 1. Scan badge | 1. Scan badge | 1. Scan badge | 1. Scan badge | 1. Scan badge |
| | and WO | and press enter | and WO | and WO | and WO |
| | 2. Enter activity | | 2. Enter | 2. Enter problem | 2. Enter the |
| | code and press | | problem | code | quantity |
| | enter | | code | 3. Press enter | of completed |
| | | | | | 3. Enter scrap |
| | | | | | quantity |
| Data Needs to be | 1. Badge Number | 1. Badge Number | 1. Badge Number | 1. Badge Number | 1. Badge Number |
| captured through | 2. WO number | 2. WO number | 2. WO number | 2. WO number | 2. WO number |
| barcode system | 3. Product ID | 3. Product ID | 3. Product ID | 3. Product ID | 3. Product ID |
| | 4. Operation ID | 4. Operation ID | 4. Operation ID | 4. Operation ID | 4. Operation ID |
| | 5. Start time | 5. End time | 5. End time | 5. End time | 5. End time |
| | for WO | for WO | for WO | for WO | for WO |
| | 6. Status of WO | | | 6. Problem code | 6. Quantity |
| | 7. Material code | | | | completed |
| | 8. Material quantity | | | | 7. Scrap quantity |
| | 9. Activity Code | | | | 8. Status of WO |
| | 10. Work station ID | | | | |
| | 11. Work Center ID | | | | |
| Other data | 1. Project ID | | | 1. Problem | 1. Project ID |
| related to the | 2. Planned start | | | descriptions | 2. Planned |
| event | time | | | | completion time |
| | 3. Actual start | | | | 3. Actual |
| | time | | | | completion time |
| | 4. Customer | | | | 4. Customer |
| | order number | | | | order number |
| | 5. Activity | | | | |
| | descriptions | | | | |

In Table Two above, the following definitions apply:

WO number: This is a number that uniquely identifies a work order that was released to shop floor to the particular workstations/work centers.

Product ID: Identifies a unique product number that was assigned by BAU.

Operation ID: Defines the detailed work instructions for a particular work order. These may be assembly instructions and/or component list.

Work Center ID: Work centers are group of machines that was identified by plant. They are usually logically grouped machines such as winding machines or assembly stations. The work center ID is the number that uniquely identifies the group. Typically, work centers are same as in ERP systems work centers.

Work Station ID: The ID of a particular machine in a work center.

Start time for WO: This indicates that work for a particular job, by a particular operator has been initiated. When the operator starts or resumes the work order, this data is updated in the database. As operator begins working in the workstation, he/she scans his/her employee ID barcode and then a barcode on the WO paper, and then finally enters an “activity code.”

End time for WO: When the operator finishes the work for that job, he/she scans the same barcodes noted above, and enters the activity code to end the job. When the operator ends the work for a work order, the end time is captured. It is preferable to capture and update this data in the database each time the operator stops or ends the work order.

Status of the work order: This data is used to trace the status of the work order. It preferably contains three statuses: “completed,” “not started,” and “started.” When the WO is in the system (e.g., the database 228), it is assigned the status of “not started.” When the operator starts to work on the work order, the status is updated to “started.” Finally, when the work is completed, the status is updated to “completed.”

Activity code: These define predetermined activities such as set up, processing, set out, etc. These codes are used to extract productive time in the shop floor.

Activity descriptions: These are the descriptions of the activity codes.

Problem codes: These are the codes that define predetermined problems such as material missing, machine breakdown, etc. These will be used to extract non-productive time in the shop floor to help point out improvement areas to the users.

Problem descriptions: These are the codes that define predetermined problems, such as material missing, machine breakdown, etc. These will be used to extract non-productive time in the shop floor. It will help the user to determine improvement areas.

Badge number: uniquely identifies an employee number.

Planned start time: This is the start time that was scheduled by the plant.

Actual start time: This is the actual start time for a particular work order. It is often different than the planned start time.

Planned completion time: This is the end time that was scheduled by the plant.

Actual completion time: This is the actual end time for a particular work order. It is often different than the planned end time.

Material code: the material code uniquely identifies a particular material or sub assembly in the work center. It may be, e.g., a number of coil drums or tanks that will be used in the stations.

Material quantity: It will be amount of material in particular workstations. Since these data will help to determine the WIP between the stations, it is preferably captured when material enter or leave the work stations Customer Order Number: A unique customer order number assigned by plant. This number is preferably tied to a work order and product ID.

Project number: These define that a unique project belongs to a particular customer.

Quantity completed: When operator finishes a work order, he or she reports the quantity completed. This field shows the completed quantity of the WO.

Scrap quantity: These are the quantity reported to the system by operators.

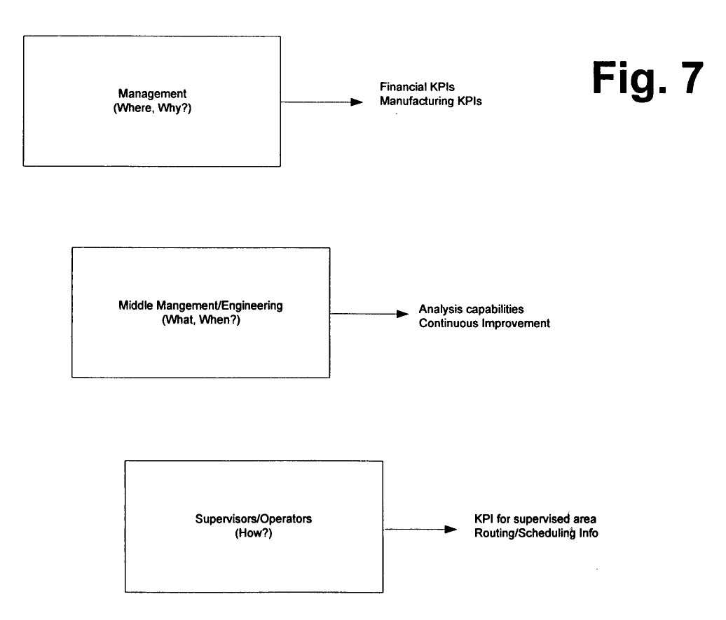

Referring now to FIG. 7, there is illustrated the various levels of information that the present invention may present to different levels of users. For example, top management may be provided financial and other critical KPI information, whereas middle management may be provided analysis capabilities for on-going activities. Further downstream, supervisors and operators may be provided with KPI information for their immediate areas and routing/scheduling information for a selected period of time. Thus, the present invention can provide all levels of employees with information specifically tailored for their needs. This advantageously reduces extraneous information and increases the relevance of the data provided to the user such that critical decisions can be made in a timely fashion. Table Three, below, further illustrates the various levels of detail that may be provided.

| | Key Performance Measures | Subject Matter | Technology | |
|---|---|---|---|---|
| User | (KPIs) | Experience | Experience | Other Attributes |
| BA Manager | Throughput time | Knowledgeable | Novice | Read English |
| | Throughput activity | of business | | |
| | analysis | | | |
| | Machine Utilization | | | |
| | (on/off, turning/not | | | |
| | turning, and capacity | | | |
| | utilization for windings, | | | |
| | oil, and filling) | | | |
| BAU Manager | Throughput time | Knowledgeable | Novice | Read English |
| | Machine Utilization | of business and | | |
| | (on/off, turning/not | manufacturing | | |
| | turning, and capacity | process | | |
| | utilization for windings, | | | |
| | oil and filling) | | | |
| | Throughput activity | | | |
| | analysis | | | |
| | WIP levels throughout the | | | |
| | plant for key components | | | |
| | Non conformity reports | | | |
| | Manufacturing work order | | | |
| | status | | | |
| Engineers/ | Throughput time | Knowledgeable | Novice | Read English |
| Supervisors | Machine Utilization | of business and | | |
| | (on/off, turning/not | manufacturing | | |
| | turning, and capacity | process | | |
| | utilization for windings, | | | |
| | oil, and filling) | | | |
| | Throughput activity | | | |
| | analysis | | | |
| | WIP levels throughout the | | | |
| | plant for key components | | | |
| | Non conformity reports | | | |
| | Manufacturing work | | | |
| | order status | | | |
| Operators | Throughput time | Knowledgeable | Novice | Read English |
| | Throughput activity | of manufacturing | | |
| | analysis | process | | |

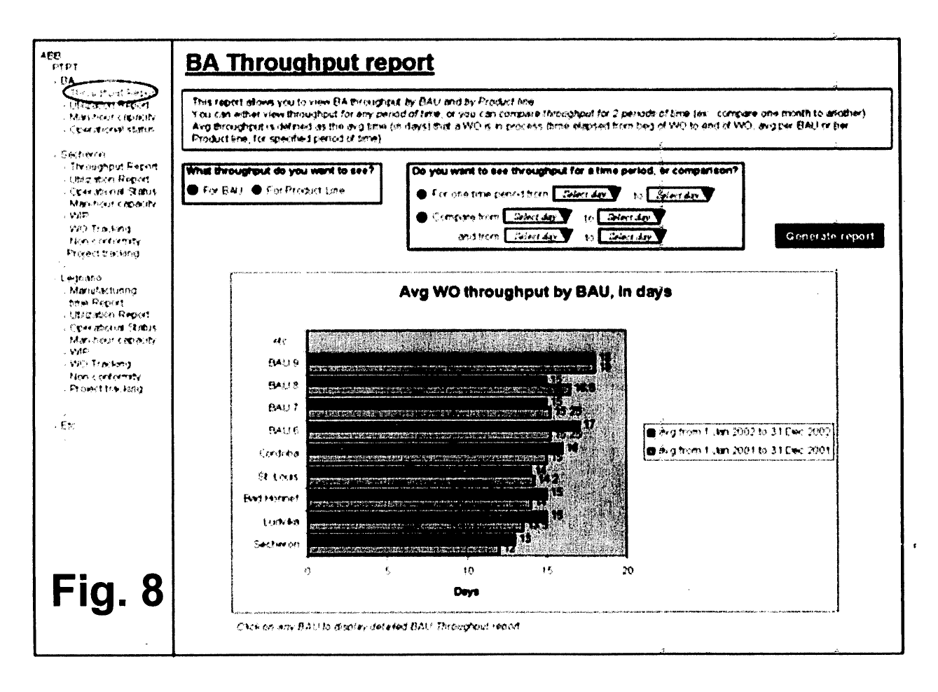

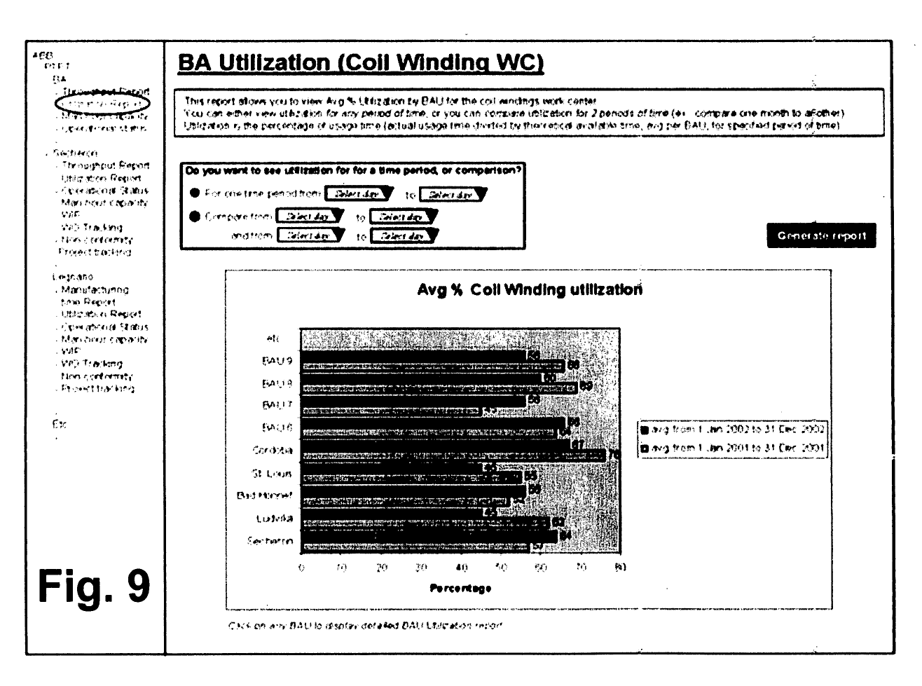

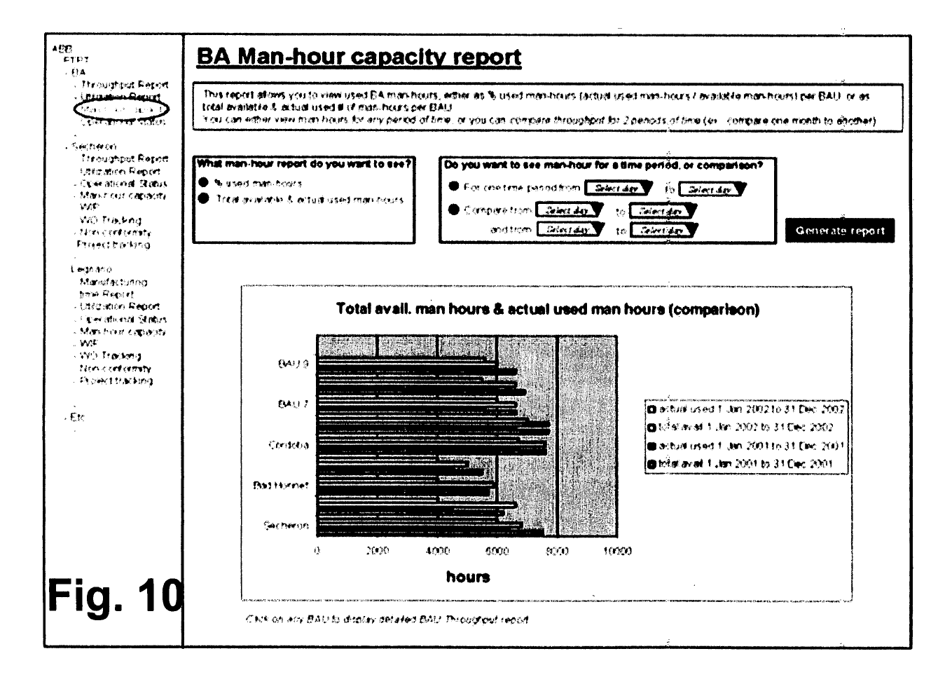

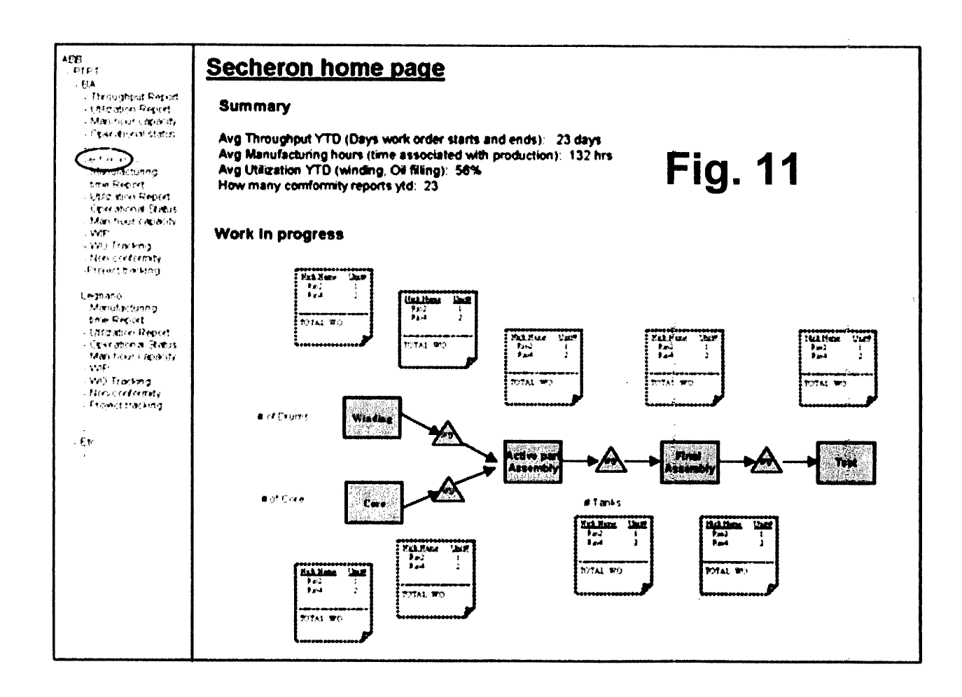

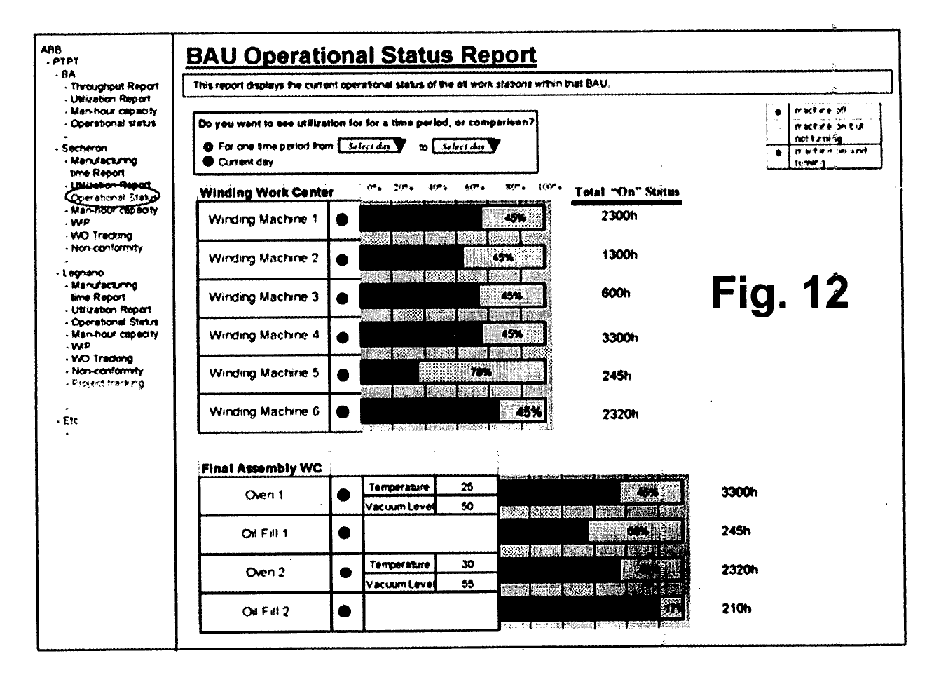

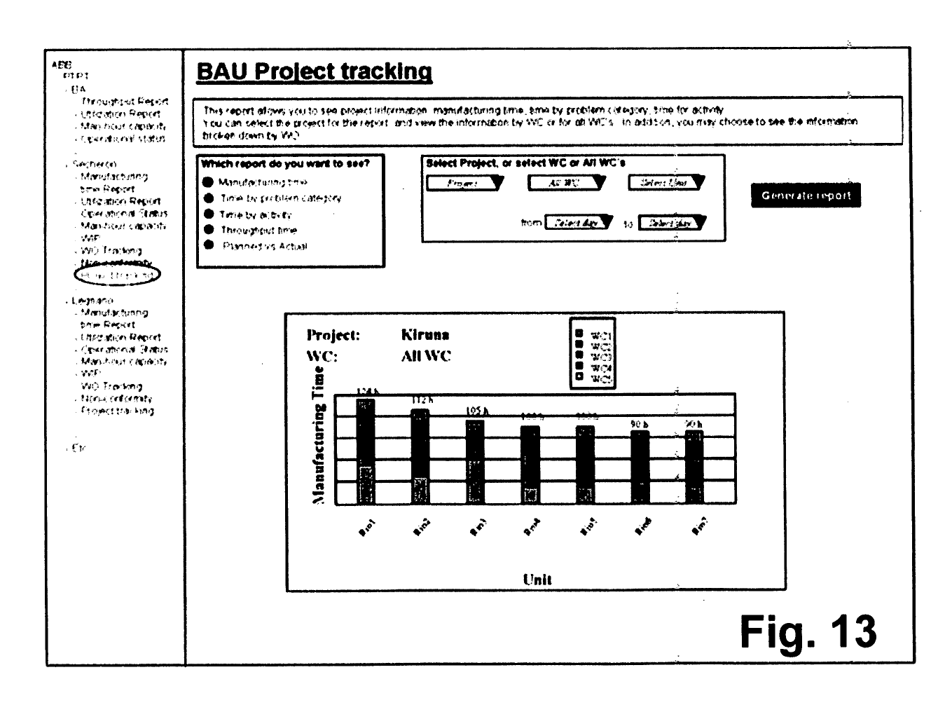

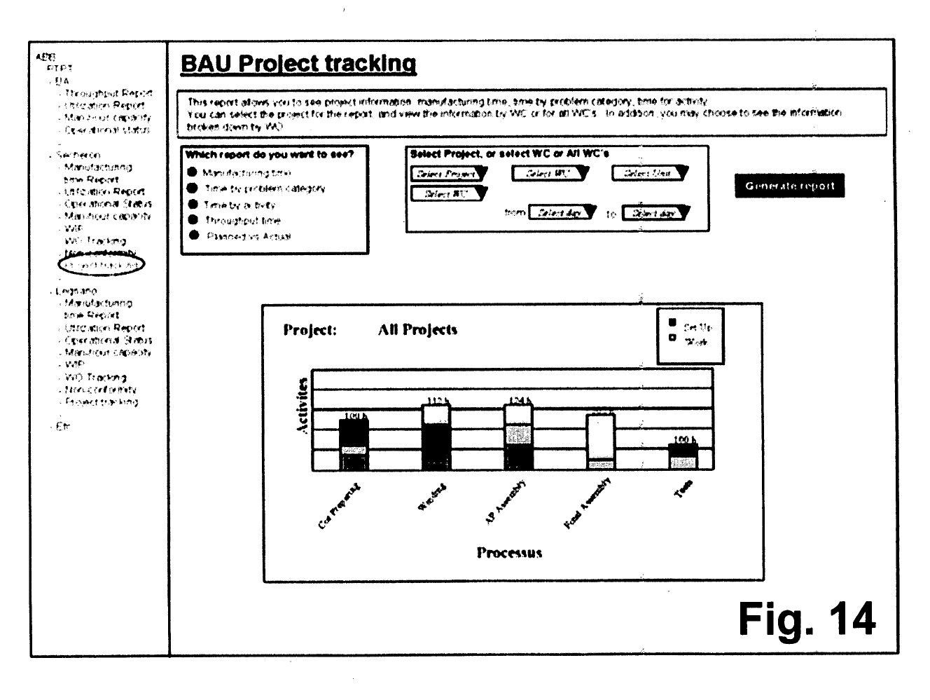

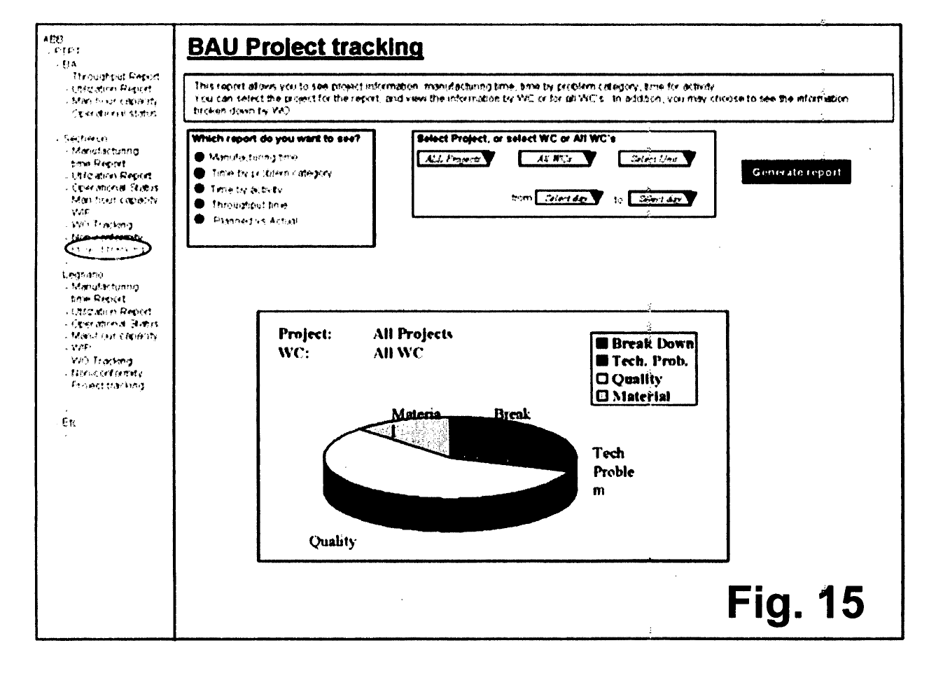

Referring now to FIGS. 8-15, there are illustrated several exemplary graphical user interfaces that are provided to the user to query various KPIs and output results with respect to various machines, WOs, and facilities. In the interfaces, the user may select from the following criteria to obtain KPI information: employees, periods of time, dates, work centers, work stations, etc. to obtain enterprise performance information. The user interfaces are not limited to those illustrated in FIGS. 8-15 as other information related to the shop floor may be provided to the user.

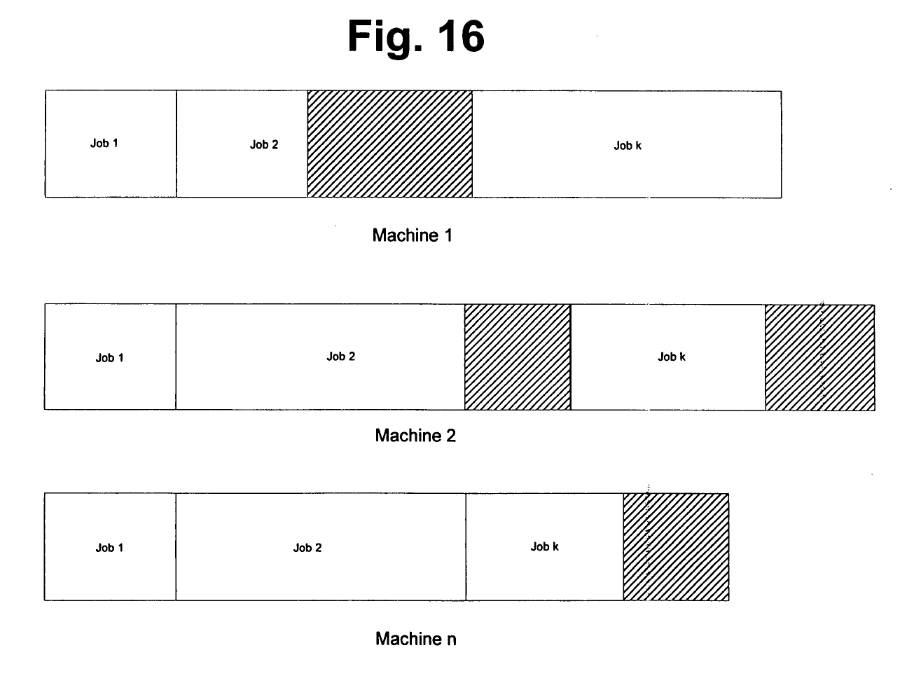

Referring now to FIG. 16, there is illustrated a number of jobs running on several machines. In accordance with the present invention, a method for minimizing the number of tardy jobs is disclosed herein. A preferred method for initial scheduling is the Earliest Due Date (EDD) method, however, any method for initial scheduling may be implemented. The present invention provides a method to control the scheduling status after a job is released to the shop floor. Thus, after a schedule is created and released to the shop floor, the present invention provides the user with a way to follow up the execution of the schedule visually.

As illustrated in FIGS. 8-15, the user may be provided with a visual indication of the difference between actual and planned schedules. For example, the user may check a particular job in the system, and reschedule the job by assigning it to a different machine if available, or continue with the current scheduling. To check for tardy jobs, the user opens an AIP scheduling screen, which consists of parameter selections and graphs to view tardy jobs. The user can select the tardiest job or a job that may have a new priority due to changed conditions (for example, customer priority).

Referring again to FIG. 16, the system shows scheduled jobs for each machine with the expected completion time. The tardiness for each job shown as a hatched portion. The user can visually determine the tardiest job or let the system determine which job is the tardiest. In the exemplary graphs, there is no tardiness for job k in machine 1. On the other hand, job k in machine 2 has tardiness.

In accordance with the present invention, the maximum tardy jobs defined as:

$${\begin{matrix}Max \{ {d}_{i} - {E}_{m} < 0 \} \\ i ∈ K\end{matrix}}_{m ∈ M}$$

$$Where$$

$$Em = {T}_{c} + {\sum }_{i = 1}^{k} {μ}_{i} + {z}_{α / 2 σ 1 …k}$$

Where
   dᵢ=Due date for job i
   Eₘ=Expected completion time of the jobs on machine m
   M=Machine set
   K=Set of jobs scheduled on selected machine
   Z_{α}=Standard normal distribution coefficient for given risk, α
   σᵢ=Standard deviation for a particular job in machine M
   μᵢ=Average duration for a particular job in machine M
   T_{c}=Current time

The preferred measure for decision making is the expected completion time for a particular job. The measure uses the average completion time plus the expected deviation for whole set of jobs. The following formula provides the expected completion time for each selected job k in each machine:

$${Min}_{j = 1}^{M} \{ {T}_{c} + {\sum }_{i = 1}^{k} {μ}_{i} + {z}_{α / 2} {σ}_{mT} \}$$

where
   σ_{mT}=SQRT(σ₁+σ₂+ . . . +σₙ)
Where
   M=Machine set
   K=Set of jobs scheduled on selected machine
   z_{α}=Standard normal distribution coefficient for given risk, α
   σ_{mT}=Total standard deviation for set of jobs in machine m
   μᵢ=Average duration for a particular job in machine M
   T_{c}=Current time

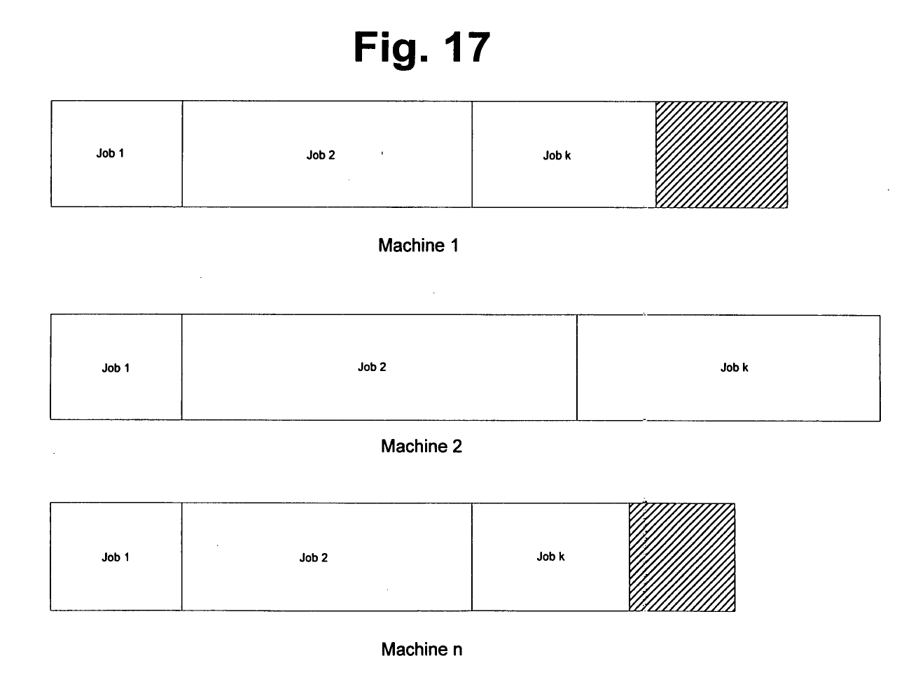

If the user wants to reschedule a job to another machine, he or she needs to check how the tardiness will change by reassigning the job to a different machine. FIG. 17 shows job k on the different machines with the tardiness. First, expected completion time for previous jobs that was assigned to a particular machine is calculated, and then expected time of the selected job added using the formulas specified above. The expected completion time will be calculated using average completion time for set of jobs assigned to the machine jobs plus total variation for the all jobs in the machines. Using the graph one can look the expected completion time and reassign the job to another machine. The user may check the expected completion times and pick a particular machine that will finish the job in earliest time possible. For example, since selected job k has no tardiness in the second machine, the user optimally reassigns the job to the second machine. Other machines have tardiness as we see in the FIG. 17.

Since changing a job assignment to a different machine will change all the calculations described above, the user continues the reassignment process until he or she is satisfied with the results. This process will can be continued by selecting next tardy job and assign it to a different machine. The user also may stop this process until all jobs checked. This process can be done at regular intervals or different intervals based on the needs of the user. This will be depend on the shop floor status and how the changes and uncertainty will affect the job scheduling. As an example, after a scheduling job is completed, a missing material may postpone a job in a particular machine. Then user then assesses the situation using the methodology above. It is also possible to simulate the different options with a calculated risk before the jobs released to the shop floor. To perform this, the user changes the standard deviation to a desired level for risk.

As is now evident to those of ordinary skill in the art, the methodology above takes into consideration uncertainty due to activities of shop floor, customer priorities, market conditions, etc. Uncertainty is considered using a normal distribution as a base model. The user assigns a confidence level within which he or she expects the completion time to fall based on the selected confidence level. For example, if user wants to be accurate 95% the time then he or she needs choose a 95% confidence level. The number (standard deviation multiplier) for the 95% confidence level will be 1.96 considering standard normal distribution. In this case, all the completion times for the jobs will be calculated using z value of 1.96. If user want to evaluate different uncertainty values, he or she simply can change the confidence level.

While the present invention has been described in connection with the preferred embodiments of the various Figs., it is to be understood that other similar embodiments may be used or modifications and additions may be made to the described embodiment for performing the same function of the present invention without deviating therefrom. For example, one skilled in the art will recognize that the present invention as described in the present application may apply to any computing device or environment, whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A system for visually displaying real-time enterprise status information related to a status of jobs running on machines, comprising:
an application integration platform that receives said real-time enterprise status information and analyzes said information to determine at least one key performance indicator;
a process control server that receives status information from at least one work center and forwards said status information to said application integration platform;
a database containing information related to manufacturing processes performed at said at least one work center; and
a graphical user interface that interfaces with said application integration platform to provide a visual display of said at least one said key performance indicator,
wherein a said system provides for minimizing the number of tardy jobs running on machines within said at least one work center.

2. The system recited in claim 1, wherein jobs are initially scheduled on said machines and wherein said system provides for control of scheduling after jobs are released to the work center shop floor.

3. The system of claim 2, wherein jobs are rescheduled from one machine to another in accordance with an expected completion time.

4. The system of claim 3, wherein said expected completion time is determined based on an average completion time for a set of jobs assigned to said machines plus a total variation for all jobs in said machines.

5. The system recited in claim 1, wherein said system graphically presents scheduled jobs for each machine and an expected completion time, wherein said expected completion time includes any tardiness.

6. The system recited in claim 5, wherein a maximum number of tardy jobs is defined as:
$${\begin{matrix}Max \{ {d}_{i} - {E}_{m} < 0 \} \\ i ∈ K\end{matrix}}_{m ∈ M}$$
$$wherein$$
$$Em = {T}_{c} + {\sum }_{i = 1}^{k} {μ}_{i} + {z}_{α / 2 σ 1 …k}$$
and wherein
dᵢ=Due date for job i
Eₘ=Expected completion time of the jobs on machine m
M=Machine set
K=Set of jobs scheduled on selected machine
z_{α}=Standard normal distribution coefficient for given risk, α
σᵢ=Standard deviation for a particular job in machine M
μᵢ=Average duration for a particular job in machine M
T_{c}=Current time.

7. The system recited in claim 5, wherein an expected completion time for a set ofjobs is defined by:
$${Min}_{j = 1}^{M} \{ {T}_{c} + {\sum }_{i = 1}^{k} {μ}_{i} + {z}_{α / 2} {σ}_{mT} \}$$
where
σ_{mT}=SQRT(σ₁+σ₂+ . . . +σₙ)
Where
M=Machine set
K=Set of jobs scheduled on selected machine
z_{α}=Standard normal distribution coefficient for given risk, α
σ_{mT}=Total standard deviation for set of jobs in machine m
μᵢ=Average duration for a particular job in machine M
T_{c}=Current time

8. The system of claim 1, wherein an uncertainty level is assigned based on an expected completion time for jobs, said uncertainty time being a time within which it is expected that a predetermined percentage of said jobs will be completed.

9. A system for visually displaying real-time enterprise management information, comprising:
an application integration platform that receives plural types of data from manufacturing and information systems within an enterprise via a network infrastructure and analyzes said plural types of data in response to user inputs to determine a level of tardiness of jobs running on manufacturing machines;
a process control server that receives manufacturing data from at least one work center and forwards said manufacturing data to said application integration platform;
a database containing information related to manufacturing processes performed at said at least one work center; and
a user interface that displays the analyzed plural types of data, one of said plural types of data being job tardiness,
wherein said at least one work center contains said manufacturing machines, and a controller that receives sensor data from said machines and communicates said sensor data to said process control server.

10. The system recited in claim 9, wherein jobs are rescheduled from one machine to another in accordance with an expected completion time, and said expected completion time is determined based on an average completion time for a set ofjobs assigned to said machines plus a total variation for all jobs in said machines.

11. The system recited in claim 9, wherein said system graphically presents scheduled jobs for each machine and an expected completion time, wherein said expected completion time includes any tardiness.

12. The system of claim 9, wherein an uncertainty level is assigned based on an expected completion time for jobs, said uncertainty time being a time within which it is expected that a predetermined percentage of said jobs will be completed.

13. The system recited in claim 9, wherein differing levels of information are provided to different classes of users, said classes of users include managers, engineers, and operators.

14. A method of visually displaying real-time enterprise management information, said method comprising:
obtaining manufacturing data from at least one work center having at least one manufacturing machine;
storing said manufacturing data in a database containing information related to manufacturing processes performed at said at least one work center;
analyzing said manufacturing data to determine jobs that are tardy; and
presenting job status to users in a manner to indicate tardy jobs.

15. The method of claim 14, further comprising:
initially scheduling jobs on said machines in accordance with a predetermined methodology; and
rescheduling jobs after jobs are released to the work center shop floor to reduce a number of said tardy jobs.

16. The method of claim 15, wherein jobs are rescheduled from one machine to another in accordance with an expected completion time.

17. The method of claim 16, wherein said expected completion time is determined based on an average completion time for a set of jobs assigned to said machines plus a total variation for all jobs in said machines.

18. The method recited in claim 14, comprising:
presenting scheduled jobs graphically for each machine, said graphical presentation including an expected completion time, wherein said expected completion time includes any tardiness.

19. The method recited in claim 18, further comprising determining a maximum number of tardy jobs in accordance with:
$${\begin{matrix}Max \{ {d}_{i} - {E}_{m} < 0 \} \\ i ∈ K\end{matrix}}_{m ∈ M}$$
$$wherein$$
$$Em = {T}_{c} + {\sum }_{i = 1}^{k} {μ}_{i} + {z}_{α / 2 σ 1 …k}$$
and wherein
dᵢ=Due date for job i
Eₘ=Expected completion time of the jobs on machine m
M=Machine set
K=Set of jobs scheduled on selected machine
z_{α}=Standard normal distribution coefficient for given risk, α
σᵢ=Standard deviation for a particular job in machine M
μᵢ=Average duration for a particular job in machine M
T_{c}=Current time.

20. The method recited in claim 18, further comprising determining an expected completion time by:
$${Min}_{j = 1}^{M} \{ {T}_{c} + {\sum }_{i = 1}^{k} {μ}_{i} + {z}_{α / 2} {σ}_{mT} \}$$
where
σ_{mT}=SQRT(σ₁+σ₂+ . . . +σₙ)
Where
M=Machine set
K=Set of jobs scheduled on selected machine
z_{α}=Standard normal distribution coefficient for given risk, a
σ_{mT}=Total standard deviation for set ofjobs in machine m
μᵢ=Average duration for a particular job in machine M
T_{c}=Current time

21. The method of claim 14, further comprising assigning an uncertainty level based on an expected completion time for jobs, said uncertainty time being a time within which it is expected that a predetermined percentage of said jobs will be completed.
